(19) United States
(12) Patent Application Publication
(10) Pub. No.: US 2014/0075288 A1
(43) Pub. Date: Mar. 13, 2014

(54) ELECTRONIC DEVICE AND METHOD FOR DISPLAYING IMAGES ON SCREEN

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/010,537

(22) Filed: Aug. 27, 2013

(30) Foreign Application Priority Data
Sep. 7, 2012 (CN) 2012103298865

(51) Int. Cl. G06F 17/22

(52) U.S. Cl. CPC G06F 17/2247
USPC 715/234

(57) ABSTRACT

In a method for displaying scalable vector graphics (SVG) images, a data acquiring method and a web document are created in a client device, data acquiring parameters are transmitted to a server using the data acquiring method, and query data corresponding to the data acquiring parameters are received from the server. The query data are stored in a data container of the web document, the query data are loaded from the data container of the web document to a preset image document, first types of elements that draw specified graphic shapes and second types of elements that display the query data on the specified graphic shapes are created. An SVG image is created using the first types and the second types of elements, and the SVG image is displayed on a display screen of the client device.

### BACKGROUND

1. Technical Field

Embodiments of the present disclosure relate to computer graphics technology, and particularly to an electronic device and method for displaying images on screen.

2. Description of Related Art

Scalable vector graphics (SVG) is an XML-based vector image format for two-dimensional graphics. SVG images and their behaviors are defined in XML text files. This means that they can be searched, indexed, scripted, and, if need be, compressed. The SVG images can be created and zoomed (zoom in or zoom out) randomly.

However, the SVG image cannot be created and displayed on a screen according to user-defined data acquired from a remote database of a server. Therefore, a more efficient method for displaying SVG images is desired.

### BRIEF DESCRIPTION OF THE DRAWINGS

FIG. 1 is a schematic diagram of a server connecting with a plurality of client computers.

FIG. 2 is a block diagram of one embodiment of a client computer including an image displaying client system.

FIG. 3 is a block diagram of one embodiment of the server including an image displaying server system.

FIG. 4 is a schematic block diagram of function modules of the image displaying client system included in the client computer.

FIG. 5 is a schematic block diagram of function modules of the image displaying server system included in the server.

FIG. 6 is a flowchart of one embodiment of a method for displaying SVG images.

FIG. 7 is a schematic diagram of query data acquired from a database of the server according to user-defined key words.

FIG. 8 is a schematic diagram of classifying the query data acquired from the database of the server.

FIG. 9 is a schematic diagram of an SVG image created according to the query data acquired from the database of the server.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

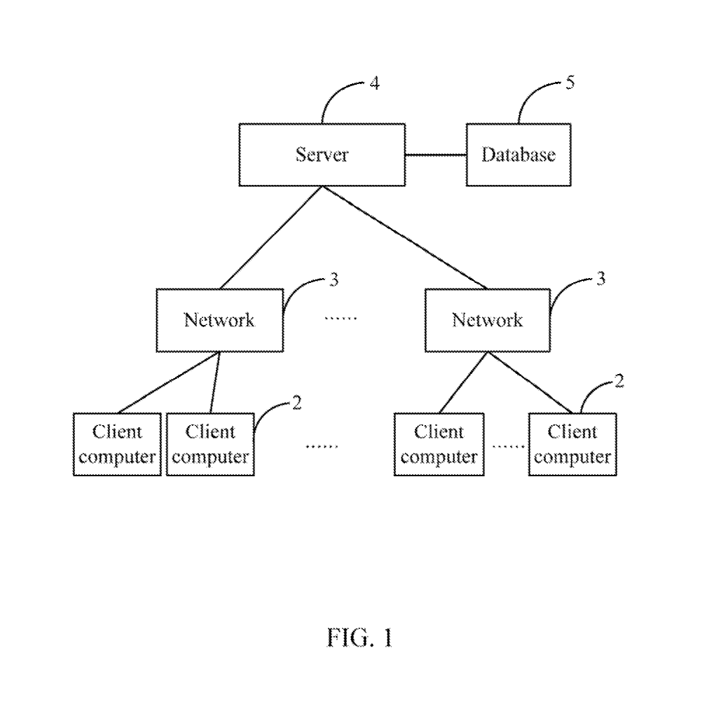

FIG. 1 is a schematic diagram of a server 2 connected to a plurality of client computers 2. In one embodiment, the server 2 is connected to the client computers 2 through a network 3. The network 3 may be an intranet, the Internet or other suitable communication network, such as general packet radio service (GPRS), WIFI/wireless local area network (WIFI/WLAN), third generation/wideband code division multiple access (3G/WCDMA), or 3.5G/high-speed downlink packet access (3.5G/HSDPA). The server 2 is further connected to a database 5 through a database connection, such as a java database connectivity (JDBC) or an open database connectivity (ODBC). In one embodiment, an image displaying client system 24 is installed in each of the client computer 2, and an image displaying server system 44 is installed in the server 2.

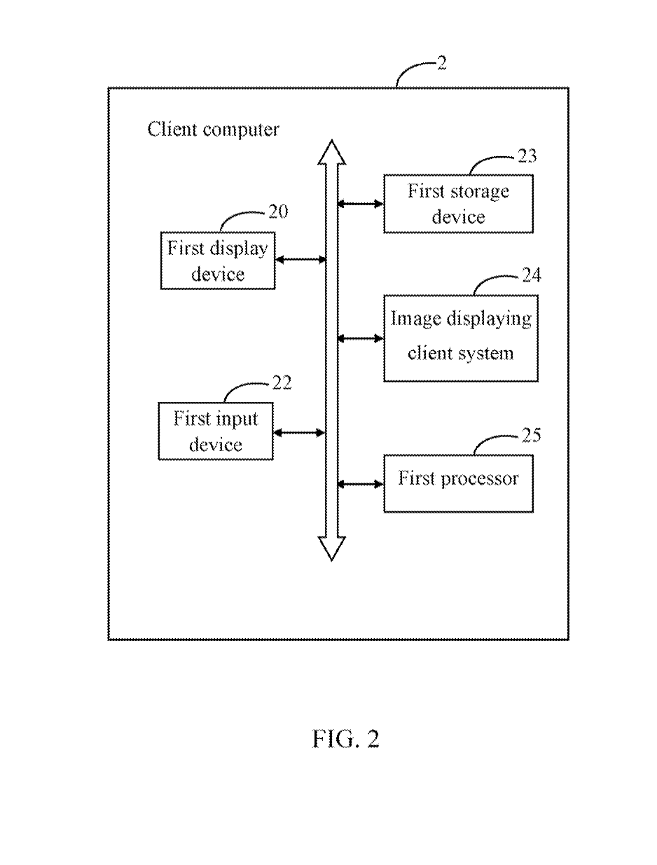

FIG. 2 is a block diagram of one embodiment of an client computer 2 including the image displaying client system 24. In one embodiment, the client computer 2 further includes a first display device 20, a first input device 22, a first storage device 23, and a first processor 25. FIG. 2 illustrates only one example of the client computer 2 that may include more or fewer components than illustrated, or have a different configuration of the various components in other embodiments. The client computer 2 may be a desk-top computer, a mobile phone, a personal digital assistant (PDA) or other suitable electronic devices.

The first display device 20 displays scalable vector graphics (SVG) images, and the first input device 22 may be a mouse or a keyboard for data input. The first storage device 23 may be a non-volatile computer storage chip that can be electrically erased and reprogrammed, such as a hard disk or a flash memory card.

In one embodiment, the image displaying client system 24 is used to obtain data for drawing SVG images from the database 5 of the server 4 according to user-defined key words (e.g., query words), and create an SVG image according to the obtained data from the database 5, so that the SVG image can be displayed on the first display device 20 dynamically according to the user-defined key words. The image displaying client system 24 may include computerized instructions in the form of one or more programs that are executed by the first processor 25 and stored in the first storage device 23 (or memory).

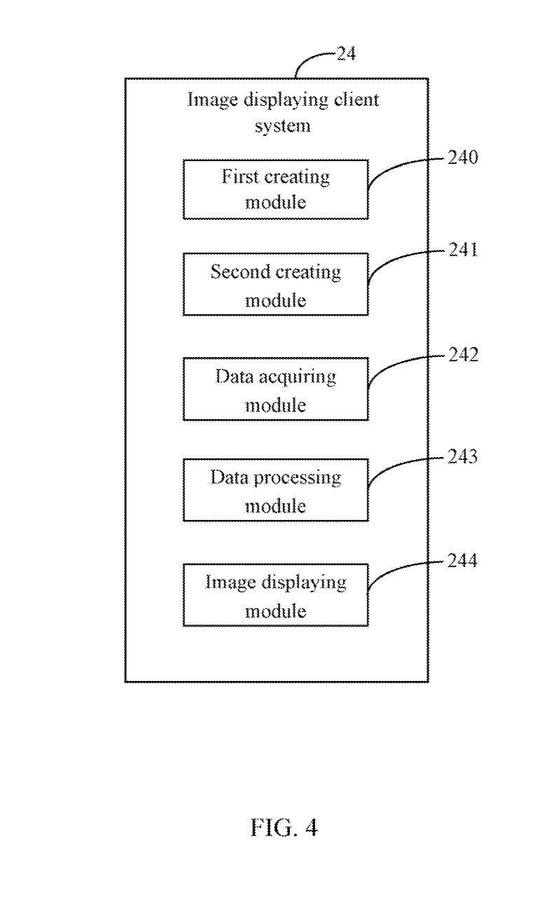

FIG. 4 is a block diagram of function modules of the image displaying client system 24 included in the client computer 2. In one embodiment, the image displaying client system 24 may include one or more modules, for example, a first creating module 240, a second creating module 241, a data acquiring module 242, a data processing module 243, and an image displaying module 244. In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include flash memory and hard disk drives.

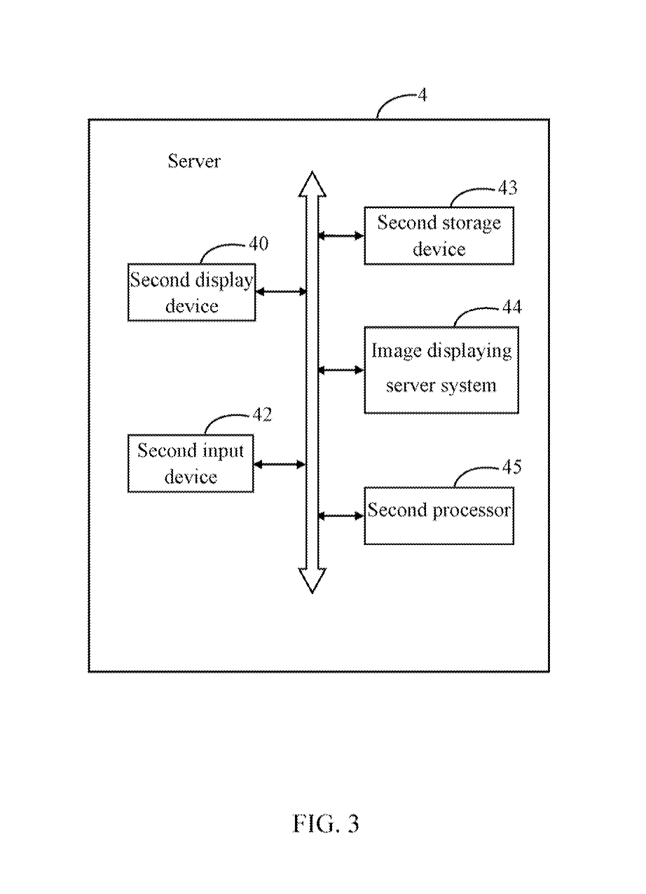

FIG. 3 is a block diagram of one embodiment of the server 4 including the image displaying server system 24. In one embodiment, the server 4 further includes a second display device 40, a second input device 42, a second storage device 43, and a second processor 45. FIG. 3 illustrates only one example of the server 4 that may include more or fewer components than illustrated, or have a different configuration of the various components in other embodiments. The second display device 40 and the second input device 22 are input/output devices of the server 4.

In one embodiment, the image displaying server system 44 is used to receive the user-defined key words from the client computer 2, obtain query data from the database 5 according to the user-defined key words, and returns the query data to the client computer 2, so that the client computer 2 creates an SVG image according to the query data acquired from the database 5, and the SVG image can be displayed on the first display device 20 dynamically according to the user-defined key words. The image displaying server system 44 may include computerized instructions in the form of one or more programs that are executed by the second processor 45 and stored in the second storage device 43 (or memory).

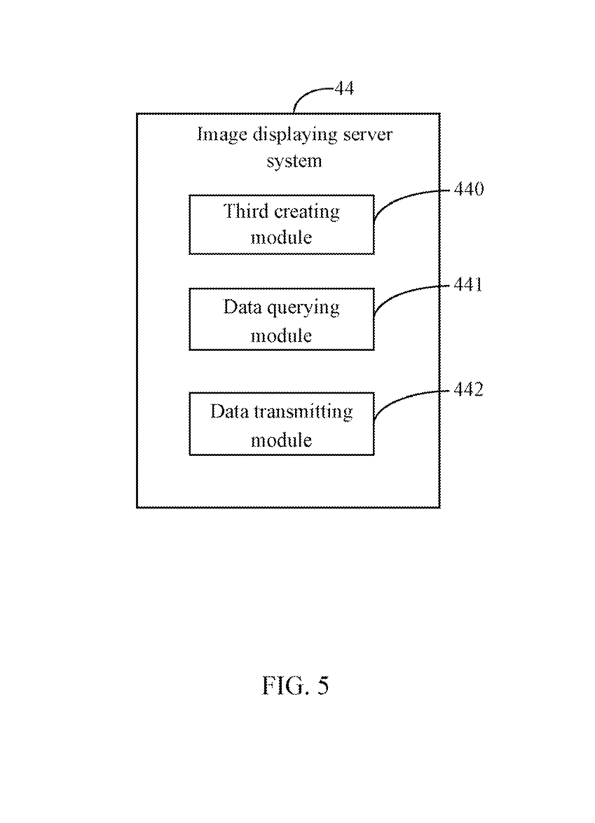

FIG. 5 is a block diagram of function modules of the image displaying server system 44 included in the server 4. In one embodiment, the image displaying server system 44 may include one or more modules, for example, a third creating module 440, a data querying module 441, and a data transmitting module 442.

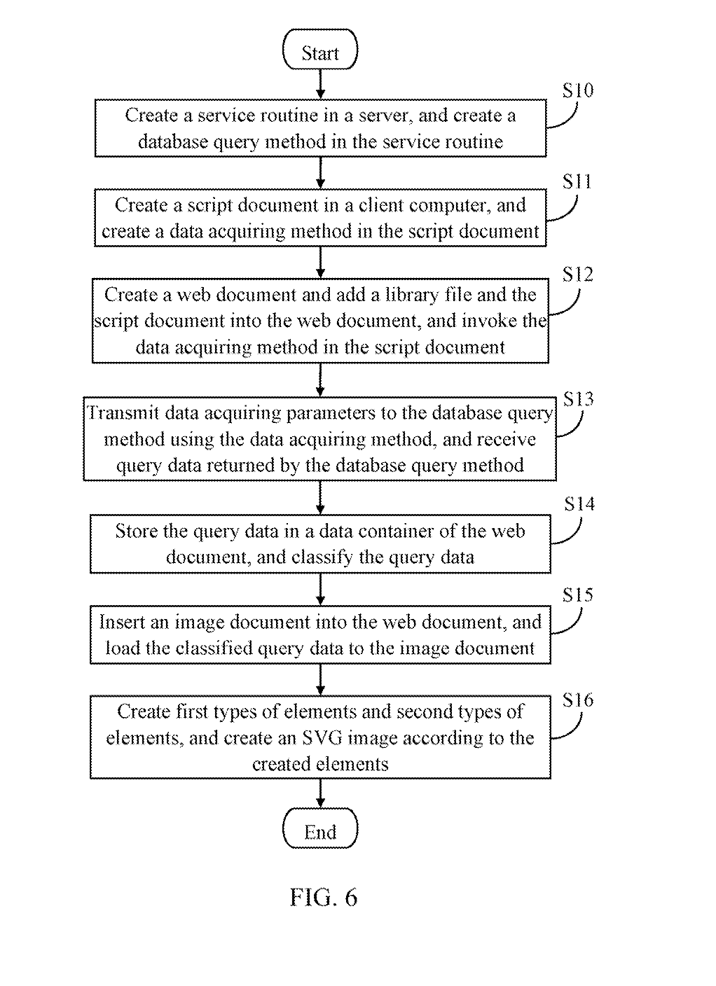

FIG. 6 is a flowchart of one embodiment of a method for displaying SVG images. Depending on the embodiment, additional steps may be added, others removed, and the ordering of the steps may be changed.

In step S10, the third creating module 440 creates a service routine (service program) in the server 4, and creates a database query method in the service routine. For example, the service routine may be a web handler file (e.g., *.ashx file), or a web service file.

In step S11, the first creating module 240 creates a script document in the client computer 2, and creates a data acquiring method in the script document. For example, the script document is a Java script file (Jscript) or other suitable format files.

In one embodiment, the data acquiring method may include a data acquiring type, data acquiring parameters, and a data acquiring address. The data acquiring type may be a post type and a get type. The data acquiring parameters may include a user name of the client computer 2 and user-defined key words. The data acquiring address may be an address of the server 4 (i.e., an address of the service routine). For example, the data acquiring address is an universal resource locator (URL) address of the server 4.

In step S12, the second creating module 241 creates a web document in the client computer 2, and adds a library file and the script document in the web document, and invokes the data acquiring method of the script document in an on-load event of the web document. In one embodiment, the library file is added to the web document at first, and then the script document is added to the web document. The web document may be a hypertext markup language (HTML) document or other suitable formats. The library file may be Java query file (JQuery file).

In step S13, the data acquiring module 242 transmits the data acquiring parameters to the database query method of the server 4 using the data acquiring method, and receives query data returned by the database query method.

In detail, if the database query method of the server 4 receives the data acquiring parameters, the data querying module 441 invokes the database query method in a specified method (e.g., a process request method) of the service routine of the server 4, and obtains query data returned by the database query method. Then, the data transmitting module 442 transmits the query data acquired by the database query method to the client computer 2 using a specified format, such as a format of Response.Write( ).

In step S14, the data processing module 243 stores the query data received by the data acquiring module 242 in a data container of the web document, and classifies the query data using Java script. In one embodiment, the data container may be the division tag having a hidden display property in the web document, such as the <Div> tag in an HTML document, and the display property of the <Div> tag is set as hidden.

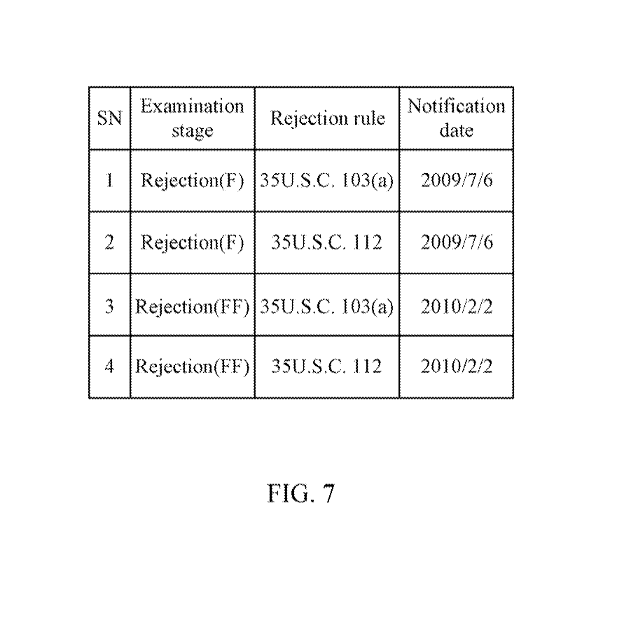

For example, when a user wants to check an examination history of a patent application, the user may enter an application number of the patent application, then the data acquiring module 242 transmits the user-defined key words (i.e., the application number of the patent application) to the data querying module 441 of the server 4. The data querying module 441 obtains examination information and documents corresponding to the patent application from the database 5 according to the application number. For example, as shown in FIG. 7, the data querying module 441 obtains four data records from the database 5, each data record includes an examination stage, a rejection rule, and a notification date. In one embodiment, the patent application is filed to the United States Patent and Trademark Office (USPTO). The examination stage “Rejection(F)” represents a first office action received from the USPTO, and the examination stage “Rejection(FF)” represents a second or a final office action received from the USPTO.

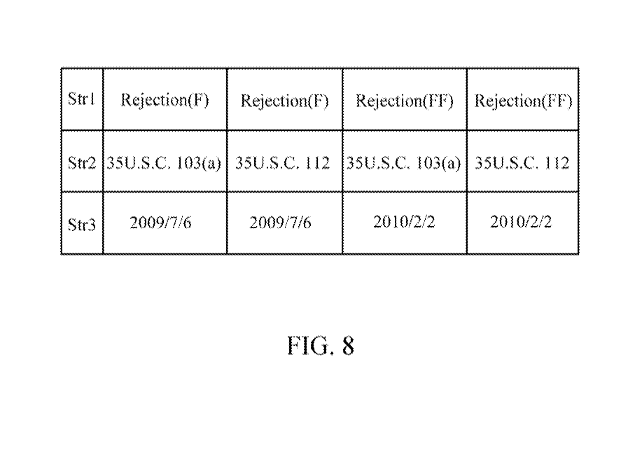

The data processing module 243 classifies the query data in FIG. 7 according to the examination stage, the rejection rule, and the notification date respectively, and obtains classified query data as shown in FIG. 8. As shown in FIG. 8, the classified query data of each type (e.g., the examination stage) is stored using a character string. For example, the query data corresponding to the examination stage is stored with a first character string “Str1”, the query data corresponding to the rejection rule is stored with a second character string “Str2”, the query data corresponding to the notification date is stored with a third character string “Str3”. A detailed representation of the three character strings is shown as follows.
Str1=Rejection(F), Rejection(F), Rejection(FF), Rejection(FF)),
Str2=(35U.S.C.103(a),35U.S.C.112,35U.S.C.103(a),35U.S.C.112), and
Str3=(2009 Jul. 6, 2009 Jul. 6, 2010 Feb. 2, 2010 Feb. 2).

In step S15, the data processing module 243 creates an image document (e.g., an SVG document), inserts the image document into the web document, such as a html file, and loads the classified query data from the data container (e.g., the <Div> tag) of the web document to the image document using the library file in the web document. In one embodiment, the data processing module 243 inserts a link or an URL address of the image document into the web document according to object type of the target in the web document, for example, inserting into an <object> tag, an <embed> tag, or an <iFrame> tag.

In step S16, the image displaying module 244 creates first types of elements which are used to draw specified graphic shapes (e.g., a line and a rectangle), and creates second types of elements which are used to display the classified query data on the specified graphic shapes. Then, the image displaying module 244 creates an SVG image using the first types and the second types of elements based on a cascading style sheet (CSS) model in the image document, and displays the SVG image on the first display device 20.

In one embodiment, the first types and the second types of the elements are document object model (DOM) elements. For example, the first types of elements may include an element used to draw a line (e.g., the <line> tag), an element used to draw a rectangle (e.g., the <rect> tag), and an element used to draw an ellipse (e.g., the <ellipse> tag). The second types of elements may be the <text> tag.

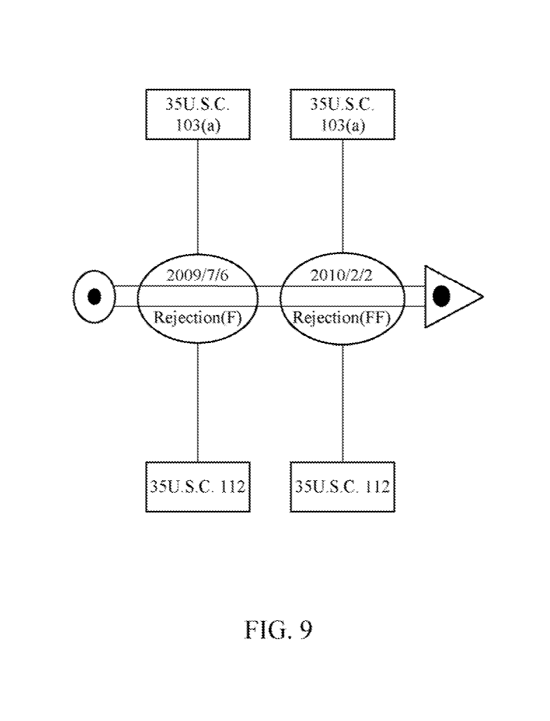

If the SVG image needed to be drawn is a fishbone diagram of the examination history of the patent application, as shown in FIG. 9, the SVG image is created according to the classified query data of FIG. 8. In detail, the image displaying module 244 obtains the first elements in the three character strings (e.g., Str1[0], Str2[0], Str3[0]), and generates a first merged data (Rejection(F), 35U.S.C.103(a), 2009 Jul. 6) by merging the first elements in the three character strings.

Using the same method as described above, the image displaying module 244 obtains the second elements in the three character strings (e.g., Str 1[1], Str2[1], Str3[1]), and generates a second merged data (Rejection(F), 35U.S.C.112, 2009 Jul. 6) by merging the second elements in the three character strings.

The image displaying module 244 obtains the third elements in the three character strings (e.g., Str1[2], Str2[2], Str3[2]), and generates a third merged data (Rejection(FF), 35U.S.C.103(a), 2010 Feb. 2) by merging the third elements in the three character strings.

The image displaying module 244 obtains the fourth elements in the three character strings (e.g., Str1[3], Str2[3], Str3[3]), and generates a fourth merged data (Rejection(FF), 35U.S.C.112, 2010 Feb. 2) by merging the fourth elements in the three character strings.

Then, the image displaying module 244 displays the four merged data on the fishbone diagram and generates an SVG image on the first display device 20. That is, the SVG image is created and displayed on the first display device 20 dynamically according to the user-defined key words (e.g., the application number of the patent application).

In other embodiments, the image displaying client system 24 and the image displaying server system 44 may be used to control displaying of other images which have features similar to those of SVG images, such as raster graphics.

In other embodiments, in step S14, the data processing module 243 does not classify the query data when the query data received by the data acquiring module 242 is stored in the data container of the web document. Thus, in step S15, the data processing module 243 loads the un-classified query data from the data container of the web document to the image document. In step S16, the image displaying module 244 creates first types of elements which are used to draw specified graphic shapes (e.g., a line and a rectangle), and creates second types of elements which are used to display the un-classified query data on the specified graphic shapes. Then, the image displaying module 244 draws an SVG image according to the created elements, and displays the SVG image on the first display device 20.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for displaying images on a display device of a client device, the method comprising:
creating a script document in the client device, and creating a data acquiring method in the script document;
creating a web document in the client device, adding a library file and the script document into the web document, and invoking the data acquiring method in the script document;
transmitting data acquiring parameters to a server using the data acquiring method, and receiving query data returned by the server;
storing the query data in a data container of the web document;
creating an image document and inserting the image document into the web document, and loading the query data from the data container of the web document to the image document using the library file in the web document; and
creating first types of elements that draw specified graphic shapes and second types of elements that display the query data on the specified graphic shapes, creating a specified image using the first types and the second types of elements, and displaying the specified image on the display device of the client device.

2. The method according to claim 1, further comprising:
classifying the query data returned by the server, and loading the classified query data from the data container of the web document to the image document using the library file.

3. The method according to claim 2, further comprising:
creating the first types of elements that draw specified graphic shapes and the second types of elements that display the classified query data on the specified graphic shapes, drawing the specified image according to the created elements, and displaying the specified image on the display device of the client device.

4. The method according to claim 1, wherein the specified image is a scalable vector graphics (SVG) image.

5. The method according to claim 1, wherein the data acquiring method of the script document is invoked using an on-load event of the web document.

6. The method according to claim 1, wherein the data container is a division tag of the web document.

7. The method according to claim 1, wherein the specified image is created using the first types and the second types of elements based on a cascading style sheet (CSS) model in the image document.

8. The method according to claim 1, further comprising:
creating a service routine in the server, and creating a database query method in the service routine;
invoking the database query method when the data acquiring parameters are received by the server, and obtaining query data from a database of the server; and
transmitting the query data acquired by the database query method to the client computer.

9. The method according to claim 8, wherein the service routine is a web handler file or a web service file.

10. The method according to claim 8, wherein the database query method is invoked using a process request method in the service routine.

11. A client device, comprising:
a processor;
a storage device storing a plurality of instructions, which when executed by the processor, causes the processor to:
create a script document in the client device, and create a data acquiring method in the script document;
create a web document in the client device, add a library file and the script document into the web document, and invoke the data acquiring method in the script document;
transmit data acquiring parameters to a server using the data acquiring method, and receive query data returned by the server;
store the query data in a data container of the web document;
create an image document and inserting the image document into the web document, and load the query data from the data container of the web document to the image document using the library file in the web document; and
create first types of elements that draw specified graphic shapes and second types of elements that display the query data on the specified graphic shapes, create a specified image using the first types and the second types of elements, and display the specified image on the display device of the client device.

12. The client device according to claim 11, wherein the plurality of instructions further comprises:
classifying the query data returned by the server, and loading the classified query data from the data container of the web document to the image document using the library file.

13. The client device according to claim 12, wherein the plurality of instructions further comprise:
creating the first types of elements that draw specified graphic shapes and the second types of elements that display the classified query data on the specified graphic shapes, drawing the specified image according to the created elements, and displaying the specified image on the display device of the client device.

14. The client device according to claim 11, wherein the specified image is a scalable vector graphics (SVG) image.

15. The client device according to claim 11, wherein the data acquiring method of the script document is invoked using an on-load event of the web document.

16. The client device according to claim 11, wherein the data container is a division tag of the web document.

17. The client device according to claim 11, wherein the specified image is created using the first types and the second types of elements based on a cascading style sheet (CSS) model in the image document.

18. A server, comprising:
a processor;
a storage device storing a plurality of instructions, which when executed by the processor, causes the processor to:
create a service routine in the server, and create a database query method in the service routine;
invoke the database query method when the data acquiring parameters are received by the server, and obtaining query data from a database of the server; and
transmit the query data acquired by the database query method to a client computer, and a specified image is created and displayed on a display screen of the client computer based on the query data.

19. The server according to claim 18, wherein the service routine is a web handler file or a web service file.

20. The server according to claim 18, wherein the database query method is invoked using a process request method in the service routine.
